(19) United States
(12) Patent Application Publication
(10) Pub. No.: US 2016/0041992 A1
(43) Pub. Date: Feb. 11, 2016

(54) DATA MANAGEMENT APPARATUS, DATA MANAGEMENT METHOD AND NON-TRANSITORY RECORDING MEDIUM

(71) Applicant: HITACHI, LTD., Tokyo (JP)

(72) Inventors: Yasushi MIYATA, Tokyo (JP); Shoji KODAMA, Tokyo (JP)

(73) Assignee: HITACHI, LTD., Tokyo (JP)

(21) Appl. No.: 14/782,237

(22) PCT Filed: Apr. 9, 2013
(86) PCT No.: PCT/JP2013/060712

§ 371 Date: Oct. 2, 2015

(51) Int. Cl. G06F 17/30

(52) U.S. Cl. CPC G06F 17/3071; G06F 17/30598; G06F 17/30528

(57) ABSTRACT

A data management apparatus includes a storage unit which stores a first database for retaining structured data in which a plurality of data features are structured based on attributes and attribute values, and a second database for retaining unstructured data in file units, and a control unit which combines the structured data and the unstructured data and manages the combination as virtual structured data which is accessed during an execution of a search query to the second database, uses attribute values of virtual attributes of the virtual structured data as values that were extracted from files of the second database based on predetermined information extraction rules, and updates the attribute values of the virtual attributes of the virtual structured data when the files of the second database including the unstructured data are updated.

### TECHNICAL FIELD

The present invention relates to a data management apparatus, a data management method and a non-transitory recording medium, and can be suitably applied to a data management apparatus, a data management method and non-transitory recording medium for managing unstructured data.

### BACKGROUND ART

Conventionally, information systems have been electronically managing a wide variety of data, and users have been collecting, processing and displaying data via information systems in order to obtain knowledge from such data. These electronic data include structured data that has structural information, and unstructured data that does not have structural information. Structured data is, for example, data in which the various features thereof are managed using structural information such as attributes and attribute values. Moreover, unstructured data does not have structures such as attributes and attribute values, and is generally managed as a file in the information system.

As described above, since structured data is organized as structural information, information systems can collect, process and display data based on the structural information. Moreover, users using the data can also utilize the structural information of the structured data and compare the attribute values of a specific attribute among the data. It is thereby possible to easily obtain the knowledge of differences or similarities among the data. Meanwhile, since the structure for expressing the data is prescribed in structured data, there is a possibility that information which does not match that structure will not be included as data.

Moreover, since the structure for expressing the data is not prescribed in unstructured data, information that cannot be expressed with structured data will also be included as data. Thus, there is a possibility that more information and knowledge can be obtained from unstructured data than from structured data. Nevertheless, since unstructured data has no structural information, it is difficult to collect data and difficult for users to discover knowledge based on structural information. Thus, disclosed are technologies for structuring data according to an information acquisition request from the user.

For example, PTL 1 discloses a technology of extracting information from a plurality of HTML documents, and thereby structuring data. This technology includes means for storing attribute information as structural information, locations of the HTML documents including information as attribute values of the attributes thereof, and rules for extracting information from the HTML documents. Consequently, upon receiving a search query based on structural information, corresponding HTML is collected from the location information of the HTML document, processing of extracting the attribute value of the attribute of each HTML document is executed, and data is thereby structured. Based on the foregoing processing, it is possible to search for unstructured data included in the HTML document as structured data.

Moreover, PTL 2 discloses a method of presenting unstructured data to a user by writing information extracted from an aggregate of unstructured data as attribute values of attributes, and thereby expressing the structurization of unstructured data. Various information systems and users can thereby manage unstructured data based on structural information.

### CITATION LIST

### Patent Literature

[PTL 1] Japanese Patent No. 3160265

[PTL 2] Japanese Unexamined Patent Application Publication (Translation of PCT Application) No. 2012-515407

### SUMMARY OF INVENTION

### Technical Problem

Meanwhile, when there are a plurality of information systems, structured data and unstructured data coexist in the data that is managed by each information system, and the contents of data are also different. In order to implement an information search across a plurality of information systems, it is necessary to combine the structured data and the unstructured data. Moreover, in order to use structural information as the basis, it is necessary to structure unstructured data, and combined it with structured data in which the structural information is known.

As described above, PTL 1 executes information extraction processing upon receiving a search query as the means for structuring data. Thus, while the latest information can be acquired at the time that the information extraction processing is executed, the time required up to acquiring the search result, which was structured for the information extraction processing, will increase. Moreover, the information extraction target is an HTML document which retains the basis of the structural information as tag information, and unstructured data is not the extraction target. Moreover, while PTL 2 discloses a method of structuring unstructured data based on the processing of extracting information based on the combination of attributes and attribute values, PTL 2 differs from PTL 1 in that it is necessary to execute information extraction processing upon receiving a search query.

The present invention was devised in view of the foregoing points, and an object of this invention is to propose a data management apparatus, a data management method and a non-transitory recording medium capable of efficiently managing unstructured data by combining the unstructured data with existing structured data.

### Solution to Problem

In order to achieve the foregoing object, the present invention provides a data management apparatus comprising a storage unit which stores a first database for retaining structured data in which a plurality of features of data are structured based on attributes and attribute values, and a second database for retaining unstructured data, which is not structured, in file units, and a control unit which combines the structured data and the unstructured data and manages the combination as virtual structured data which is accessed during an execution of a search query to the second database, uses attribute values of virtual attributes of the virtual structured data as values that were extracted from files of the second database based on predetermined information extraction rules, and updates the attribute values of the virtual attributes of the virtual structured data when the files of the second database including the unstructured data are updated.

According to the foregoing configuration, the structured data and the unstructured data are combined and the combination is used as virtual structured data which is accessed during an execution of a search query to the second database, and the attribute values of the virtual attributes of the virtual structured data are used as values that were extracted from files of the second database based on predetermined information extraction rules. Furthermore, the attribute values of the virtual attributes of the virtual structured data are updated when the files of the second database including the unstructured data are updated. Consequently, it is possible to acquire the intended extracted data by merely accessing the structured data which reflects the state of the latest unstructured data without having to execute re-extraction processing to the unstructured data of the extraction source each time search processing is executed.

### Advantageous Effects of Invention

According to the present invention, unstructured data can be efficiently managed by combining the unstructured data with existing structured data.

### BRIEF DESCRIPTION OF DRAWINGS

FIG. 1 is a block diagram showing the configuration of the data management apparatus according to the first embodiment of the present invention.

FIG. 2 is a conceptual diagram showing the contents of the information extraction rules according to the first embodiment.

FIG. 3 is a conceptual diagram explaining the contents of the virtual structured data according to the first embodiment.

FIG. 4 is a diagram showing an example of the related file information according to the first embodiment.

FIG. 5 is a flowchart showing the information extraction rule registration processing according to the first embodiment.

FIG. 6 is a flowchart showing the virtual attribute value/initial value determination processing according to the first embodiment.

FIG. 7 is a flowchart showing the virtual attribute update processing according to the first embodiment.

FIG. 8 is a conceptual diagram showing an example of the virtual structured data management screen according to the first embodiment.

FIG. 9 is a block diagram showing the configuration of the data management apparatus according to the second embodiment of the present invention.

FIG. 10 is a flowchart showing the added file verification processing according to the second embodiment.

FIG. 11 is a block diagram showing the configuration of the data management apparatus according to the third embodiment of the present invention.

FIG. 12 is a flowchart showing the processing of expanding the information extraction rules according to the third embodiment.

FIG. 13 is a conceptual diagram explaining the expansion of the information extraction rules according to the third embodiment.

FIG. 14 is a block diagram showing the configuration of the data management apparatus according to the fourth embodiment of the present invention.

FIG. 15 is a flowchart showing the processing of calculating the related strength according to the fourth embodiment.

FIG. 16 is a diagram showing an example of the related file information according to the fourth embodiment.

FIG. 17 is a block diagram showing the configuration of the data management apparatus according to the fifth embodiment of the present invention.

FIG. 18 is a flowchart showing the information extraction processing which uses the statistical information according to the fifth embodiment.

FIG. 19 is a conceptual diagram explaining an example of the statistics calculation rules according to the fifth embodiment.

### DESCRIPTION OF EMBODIMENTS

An embodiment of the present invention is now explained in detail with reference to the drawings.

### (1) First Embodiment

### (1-1) Configuration of Data Management Apparatus

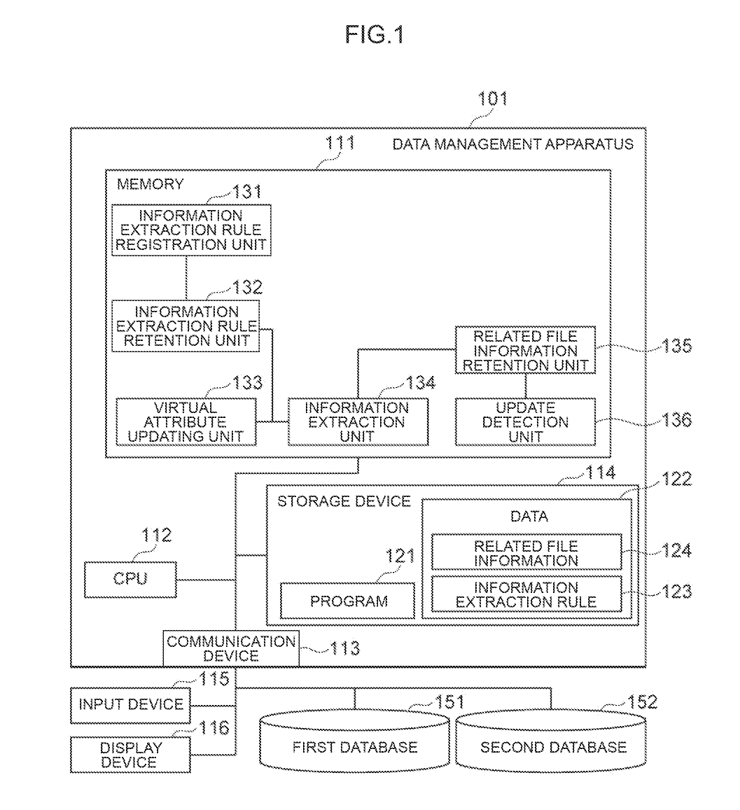

The hardware configuration of the data management apparatus 101 is foremost explained with reference to FIG. 1. As shown in FIG. 1, a data management apparatus 101 comprises a memory 111, a CPU 112, a communication device 113, a storage device 114, an input device 115 and a display device 116.

The CPU 112 functions as an arithmetic processing unit and a control unit, and controls the overall operation of the data management apparatus 101 according to the various programs stored in the memory 111. The memory 111 is, for instance, a ROM (Read Only Memory) or a RAM (Random Access Memory), and a ROM 202 stores programs and arithmetic parameters used by the CPU 112, and a RAM 203 temporarily stores programs used in the processing executed by the CPU 112 and parameters that are changed as needed during such execution of processing. These components are mutually connected via a host bus configured from a CPU bus or the like.

The CPU 112 is configured from an information extraction rule registration unit 131, an information extraction rule retention unit 132, a virtual attribute updating unit 133, an information extraction unit 134, a related file information retention unit 135 and an update detection unit 136. These components of the CPU 112 are used for registering information extraction rules described later, executing information extraction processing, registering related file information, and managing the update of virtual structured data according to the registered information extraction rules. Processing that is executed by the respective components will be described in detail later.

The communication device 113 is a communication interface configured from a communication device or the like for connecting to a network. Moreover, the communication device 113 may be a wireless LAN (Local Area Network)-compatible communication device, a wireless USB-compatible communication device, or a wired communication device performs wired communication.

The storage device 114 is configured, for example, from an HDD (Hard Disk Drive), and stores programs to be executed by the CPU 112 and various data. Moreover, a first database 151 and a second database 152 described later may be stored in the storage device 114, or stored in a storage device that is separate from the data management apparatus 101.

The storage device 114 stores various programs 121, data 122, information extraction rules 123, and related file information 124 that are used by the data management apparatus 101 to execute processing. The various types of information stored in the storage device 114 will be described in detail later.

The input device 115 is a device such as a keyboard or a mouse for inputting instructions to a computer, and inputs instructions for activating programs and so on.

The display device 116 is a display or the like, and displays the execution status and execution result of the processing executed by the data management apparatus 101.

### (1-2) Function of Data Management Apparatus

The structured data and the unstructured data managed in the data management apparatus 101 are foremost explained. The structured data is explained using a relational database taking as an example data having the structure of attributes and attribute values. In a relational database, data is expressed as a record, and attributes are expressed as a column name. Attribute values are written into cells corresponding to specific attributes in the record. The unstructured data is explained taking as an example a file containing document information, image information, video information or audio information.

Moreover, the ensuing explanation is provided on the assumption that the first database 151 described later stores structured data, and the second database stores unstructured data such as files.

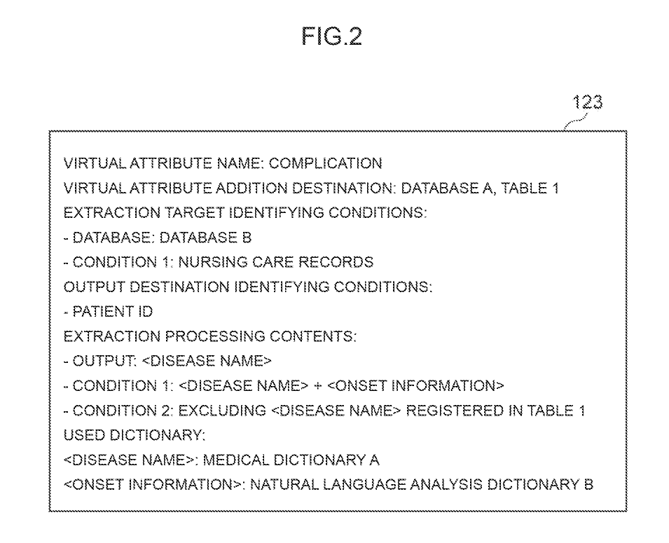

The information extraction rule registration unit 131 receives the information extraction rules 123 via the communication device or the input device, extracts, from the virtual attribute addition destination, the virtual attribute name included in the information extraction rules 123 and table information as the virtual attribute addition destination, and stores the extracted information in the extraction rule retention unit 132. The information extraction rules 123 are now explained with reference to FIG. 2.

The information extraction rules 123 prescribe the rules for extracting predetermined information, and are stored in a storage device by the information extraction rule registration unit 131. As shown in FIG. 2, the information extraction rules 123 contain information such as a virtual attribute name, a virtual attribute addition destination, extraction target identifying conditions, output destination identifying conditions, extraction processing contents and a used dictionary.

The virtual attribute name is information for identifying the writing position in the structured data, and the result of extracting information from the file included in the unstructured data is written into the structured data. The virtual attribute addition destination is information for identifying the database and the table to which the virtual attribute name is to be added. The extraction target identifying conditions are database information containing the unstructured data from which information is to be extracted and the conditions for narrowing down the extraction target. The output destination identifying conditions are conditions for identifying the position in the table as the writing destination of the result extracted from the unstructured data. The extraction processing contents include the name of the attribute value to be output as the extraction result, and the extraction conditions of such attribute value. The used dictionary is information for setting the dictionary to be referred to during information extraction.

With the information extraction rules 123 shown in FIG. 2, the virtual attribute name is “complication”, and the table of the first database 151 as the virtual attribute addition destination is a table 1 of a database A. Moreover, the file of the second database 152 as the extraction target is the nursing care record file of a database B. Moreover, the extraction result is to be written at the position identified with the patient ID of the table 1.

Moreover, the name of the attribute value to be output as the extraction result is “disease name”, and the disease name defined in a medical dictionary A is to be extracted as the disease name. The term “onset information” means, for instance, upon analyzing natural language, information for determining whether information having the same meaning as the onset is included such as “develop an illness”, “contract a disease”, or “have a symptom”. If there is a description to the effect that the disease name indicated in the medical dictionary A was developed according to a condition 1 of the extraction processing contents, then that disease name is extracted.

Note that the information extraction rules 123 shown in FIG. 2 are an example, and if there are a plurality of results from extracting information, a list of a plurality of output results may be written as the virtual attribute value. Moreover, the information extraction rules 123 may also include rules for writing the number of results of all searchers performed to the second database in the virtual attribute values, rules for writing the location information of related files, or rules for writing the results of statistical processing performed to the information in the related files.

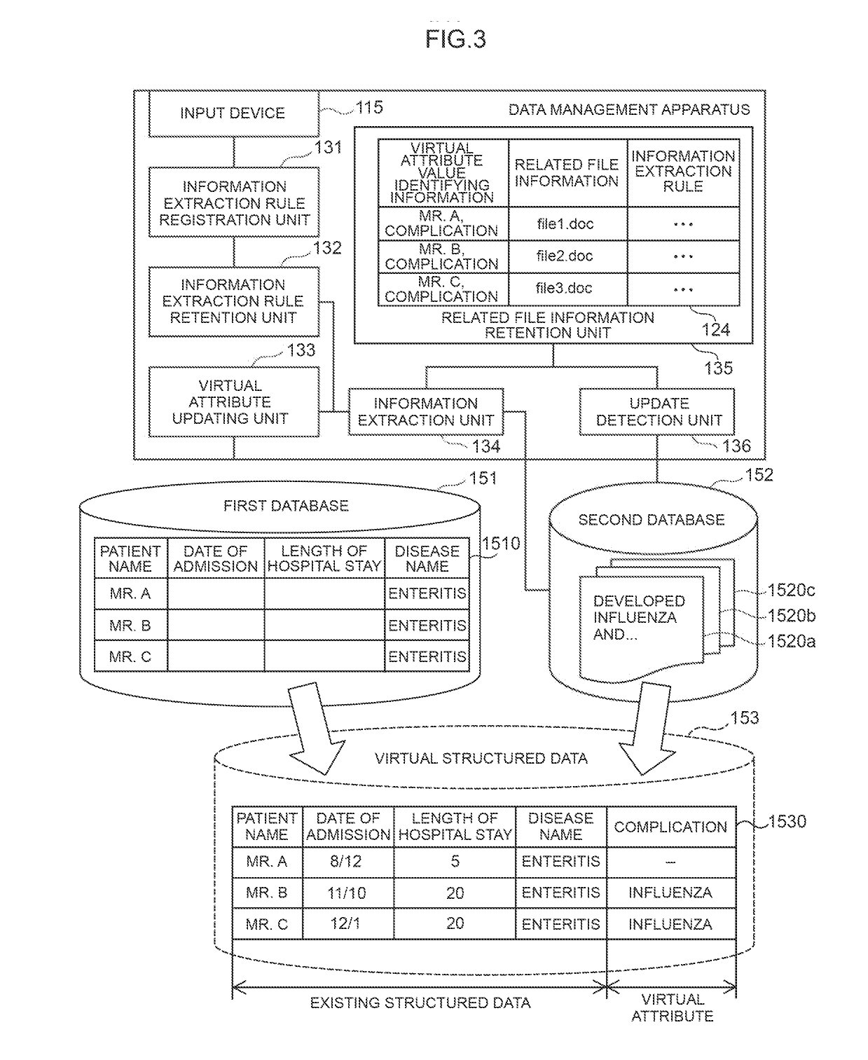

The virtual structured data 153 is now explained with reference to FIG. 3. The information extraction rule registration unit 131 identifies the database (first database 151) as the virtual attribute addition destination and the table 1510 that is included in that database by using information that is set in the virtual attribute addition destination of the information extraction rules 123. The information extraction rule registration unit 131 generates the virtual structured data 153 by adding, to the table of the identified database, a column in which the virtual attribute name is used as the column name. Here, rather that actually adding a column to the table, it is also possible to generate the virtual structured data 153 by newly creating a table configured from a unique ID for uniquely identifying the record included in the table, and a virtual attribute. After the virtual attribute is added to the identified table as described above, information for determining the initial value that is set as the virtual attribute is extracted, and the related file information 124 described later is registered in the related file information retention unit 135.

The information extraction unit 134 refers to the extraction target identifying conditions included in the information extraction rules 123, and identifies a file among a file 1520a or a file 1520b or a file 1520c (these files may be hereinafter collectively referred to as the “file 1520”) of the database (second database 152) from which information is to be extracted. Subsequently, the file is identified by using the information set in the output destination identifying conditions, and the position of the virtual attribute value as the writing destination of the information extracted from that file is identified. For example, with the information extraction rules 123 shown in FIG. 2, since the patient ID is designated as the output destination identifying conditions, the file of the nursing care record is identified for each patient, and the position of writing the information extracted from that file is identified from the column of the virtual attribute value in the table 1530 of the virtual structured data 153.

Moreover, the information extraction unit 134 registers, in the related file information 124, the identified file as a related file by associating it with the virtual attribute value identifying information for identifying the position of the virtual attribute value. For example, with the information extraction rules 123 shown in FIG. 2, since the patient ID is designated as the output destination identifying conditions, the file of the nursing care record of each patient is registered in the related file information 124 as the related file to be associated with the virtual attribute value of each patient.

Subsequently, the information extraction unit 134 executes information extraction processing to the related file associated with the related file information 124 for each identified virtual attribute value, and writes the result in the virtual structured data 153 as the virtual attribute value in which the extraction result was identified.

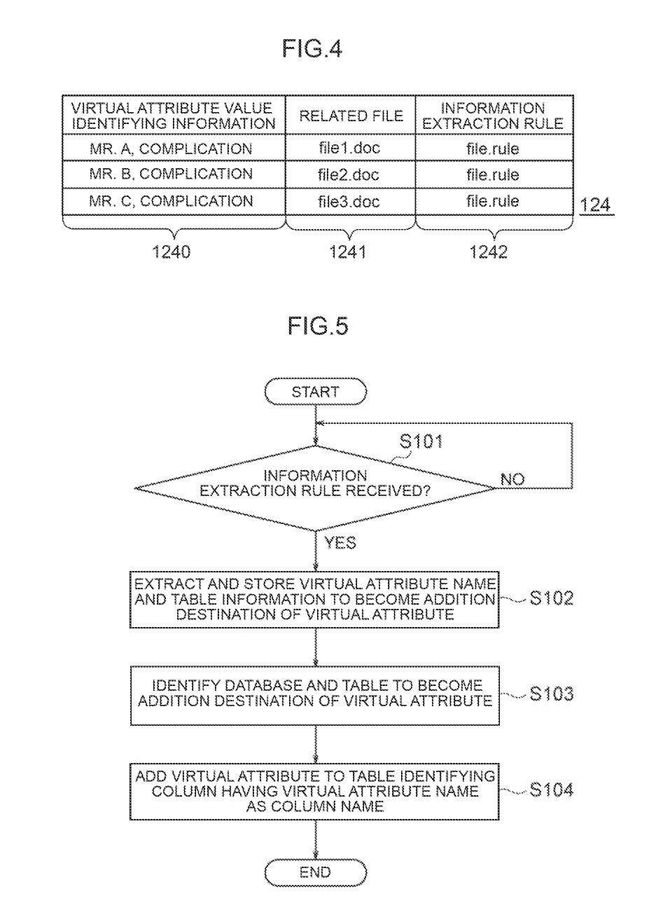

Moreover, the information extraction unit 134 associates the information registered in the related file information 124 of the related file information retention unit 135 with the information extraction rules, and registers the association. The related file information 124 shown in FIG. 4 is thereby retained in the related file information retention unit 135.

As shown in FIG. 4, the related file information 124 is configured from a virtual attribute value identifying information column 1240, a related file column 1241 and an information extraction rule column 1242. The virtual attribute value identifying information column 1240 stores information for identifying the position of the virtual attribute value of the virtual structured data 153 as the writing destination of information extracted from the file. The related file column 1241 stores, as the related file, information for identifying the file to be extracted. The information extraction rule column 1242 stores information showing the information extraction rules 123.

In FIG. 4, for instance, the writing destination of the virtual attribute value that was extracted from the related file “file1” (nursing care record file of each patient) according to the information extraction rule “file.rule” is the position identified with the row of the complication column in the line of patient name “Mr. A” in the nursing care record table 1530 of the virtual structured data 145.

Accordingly, information showing the related file from which information is to be extracted and the information extraction rules can be set by being associated with the related file information 124 of the related file information retention unit 135. Moreover, the virtual structured data 153 is generated by extracting the virtual attribute value from the designated related file according to the information extraction rules of the related file information 124, and setting the virtual attribute value at the position indicated by the virtual attribute value identifying information.

Returning to FIG. 1, the update detection unit 136 verifies whether the updated file matches the related file set in the related file information 124 when the file included in the second database 152 is updated. Here, whether the file has been updated is determined, for example, based on whether the updated date of the file has been changed. Moreover, the update of a file includes the deletion of a file.

Subsequently, when a related file that matches the updated file exists in the related file information 124, the update detection unit 136 executes the information extraction processing according to the information extraction rules 123 associated with that related file. The virtual attribute updating unit 133 updates the extracted result as the virtual attribute value of the position that is identified by the output destination identifying conditions and the virtual attribute name.

Accordingly, when the data extracted from the unstructured data is combined with the existing structured data and managed as the virtual structured data 153 and the unstructured data is updated, the virtual structured data 153 is also updated and becomes latest data. Consequently, it is possible to acquire the intended extracted data by merely accessing the virtual structured data 153 which reflects the state of the latest unstructured data without having to execute re-extraction processing to the unstructured data of the extraction source each time search processing is executed to the virtual structured data 153.

### (1-3) Detailed Operation of Data Management Apparatus

The detailed operation of the data management apparatus 101 is now explained. The data management apparatus 101 foremost executes the information extraction rule registration processing of registering the virtual attribute name and the virtual attribute addition destination based on the input information extraction rules 123. Subsequently, the data management apparatus 101 executes the virtual attribute value/initial value determination processing of extracting data from the file from which information is to be extracted according to the information extraction rules 123, and writing the extraction result as the virtual attribute value at the position identified in the table 1530 of the writing destination of the virtual structured data 153. In addition, when the file included in the second database 152 is updated, the virtual attribute update processing of updating the virtual attribute corresponding to the updated file is executed. Each processing is now explained in detail.

### (1-3-1) Information Extraction Rule Registration Processing

The information extraction rule registration processing is now explained in detail with reference to FIG. 5. As shown in FIG. 5, the information extraction rule registration unit 131 determines whether the information extraction rules 123 have been received via the communication device 113 or the input device 115 (S101).

Subsequently, when it is determined that the information extraction rules 123 have been received in step S101, the information extraction rule registration unit 131 extracts the virtual attribute name included in the information extraction rules 123 and the information set in the virtual attribute addition destination, and stores the table information to become the virtual attribute name and the virtual attribute addition destination in the related file information retention unit 135 (S102).

Subsequently, the information extraction rule registration unit 131 identifies the database to become the virtual attribute addition destination and the table included in that database (S103). Specifically, when “database A, table 1” is set as the virtual attribute addition destination of the information extraction rules 123, the information extraction rule registration unit 131 identifies the database A as the database to become the virtual attribute addition destination, and additionally identifies the table 1 included in the database A.

Subsequently, the information extraction rule registration unit 131 adds, to the table identified in step S103, a column in which the virtual attribute name of the information extraction rules 123 is used as the column name (S104). Specifically, when “complication” is set as the virtual attribute name of the information extraction rules 123, the information extraction rule registration unit 131 adds, to the table 1 identified in step S103, a column in which the column name is “complication”.

### (1-3-2) Virtual Attribute Value/Initial Value Determination Processing

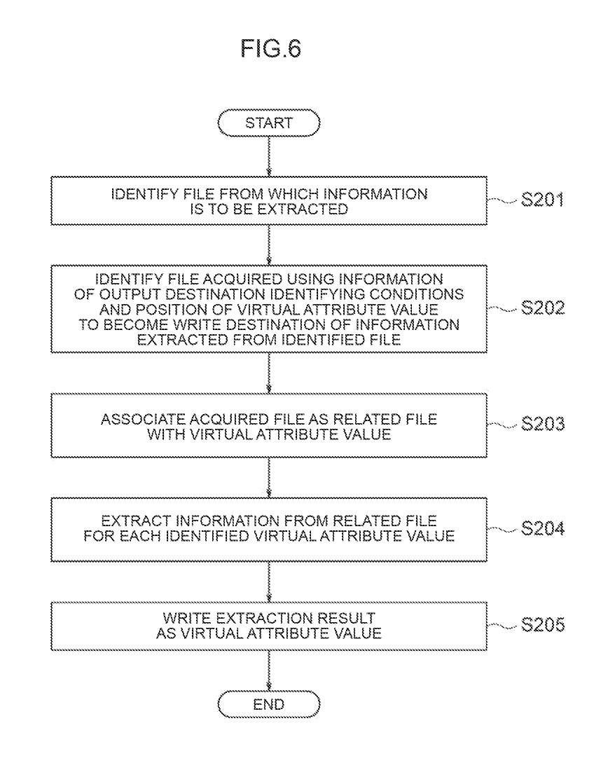

The virtual attribute value/initial value determination processing is now explained in detail with reference to FIG. 6. As shown in FIG. 6, the information extraction unit 134 identifies the file from which information is to be extracted according to the extraction target identifying conditions that are set in the information extraction rules 123 (S201).

Subsequently, the information extraction unit 134 identifies the file by using the information of the output destination identifying conditions of the information extraction rules 123, and identifies the position of the virtual attribute value to become the writing destination of the information extracted from that file (S202). Specifically, the information extraction unit 134 identifies the file of the nursing care record for each patient when the output destination identifying conditions are the patient ID. Subsequently, the information extraction unit 134 identifies the position of writing the virtual attribute value in the table 1530 of the virtual structured data 153 as the writing destination of the information extracted from the file of the nursing care record.

Subsequently, the information extraction unit 134 registers, as the related file, the file identified in step S202 in the related file information 124 by associating it with the virtual attribute value identifying information for identifying the position of the virtual attribute value (S203). Specifically, the information extraction unit 134 registers the file of the nursing care record for each patient in the related file information 124 as the related file to be associated with the virtual attribute value of each patient since the patient ID is designated as the output destination identifying conditions in the information extraction rules 123.

Subsequently, the information extraction unit 134 executes the information extraction processing to the related files associated in the related file information 124 for each identified virtual attribute value (S204). Subsequently, the information extraction unit 134 writes, as the virtual attribute value, the result of the extraction processing executed in step S204 at the identified writing position in the table 1530 of the virtual structured data 153 (S205).

Based on the virtual attribute value/initial value determination processing described above, information showing the related file from which information is to be extracted and the information extraction rules can be associated and stored in the related file information 124 of the related file information retention unit 135. Moreover, the virtual structured data 153 is generated by extracting the virtual attribute value from the designated related file according to the information extraction rules of the related file information 124, and setting the virtual attribute value at the position indicated by the virtual attribute value identifying information.

### (1-3-3) Virtual Attribute Update Processing

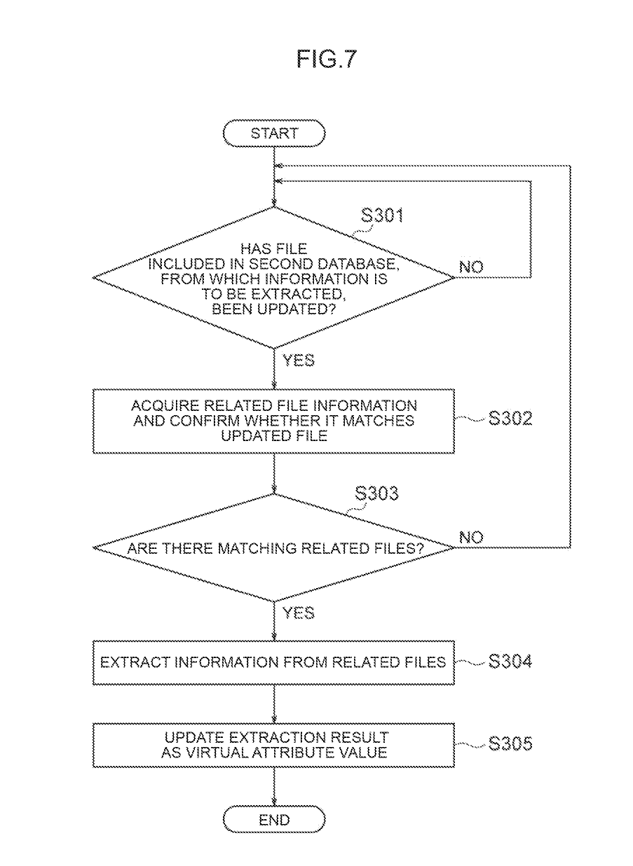

The virtual attribute update processing is now explained in detail with reference to FIG. 7. As shown in FIG. 7, the update detection unit 136 determines whether the file included in the second database 152 from which information is to be extracted has been updated (S301).

When it is determined that the file has been updated in step S301, the update detection unit 136 acquires the related file information 124 retained in the related file information retention unit 135, and confirms whether there is a file that matches the updated file (S302).

Subsequently, the update detection unit 136 determines whether there is a matching related file in the verification of step S302 (S303). When it is determined that there is no matching file in step S303, the update detection unit 136 once again repeats the processing of step S301 onward. Meanwhile, when it is determined that there is a matching file in step S303, the update detection unit 136 executes the processing of step S304.

The update detection unit 136 executes the information extraction processing to the matching related file according to the information extraction rules 123 corresponding to the related file information 124 (S304). Subsequently, the virtual attribute updating unit 133 updates the result extracted in the information extraction processing executed in step S304 as the virtual attribute value of the position that is identified based on the output destination identifying conditions and the virtual attribute name (S305).

As described above, when the data extracted from the unstructured data is combined with the existing structured data and managed as the virtual structured data 153 and the unstructured data is updated, the virtual structured data 153 is also updated and becomes latest data. Consequently, it is possible to acquire the intended extracted data by merely accessing the virtual structured data 153 which reflects the state of the latest unstructured data without having to execute re-extraction processing to the unstructured data of the extraction source each time search processing is executed to the virtual structured data 153.

### (1-4) Virtual Structured Data Management Screen

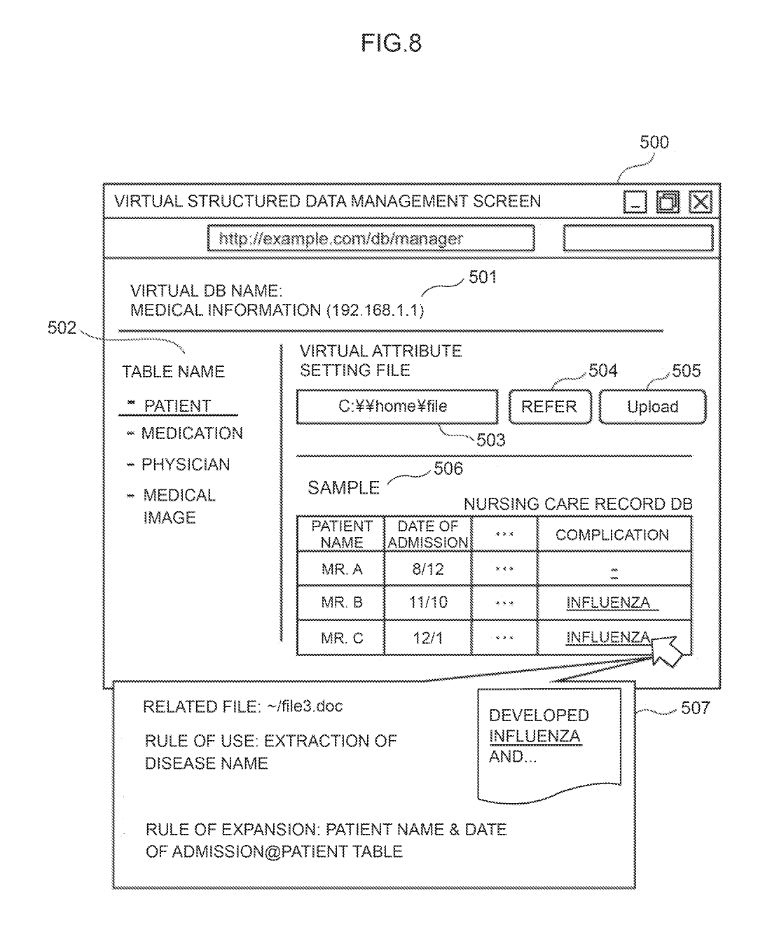

The virtual structured data management screen 500 is now explained with reference to FIG. 8. The virtual structured data management screen 500 is a screen that is used by the user for managing the virtual structured data. FIG. 8 shows an example of managing a virtual structured database having an IP address of 192.168.1.1 as the access point and given the name of “medical information”.

As shown in FIG. 8, the virtual DB name 501 displays medical information showing the database name, and 192.168.1.1 indicating the IP address. In addition, the table name 502 displays a list of the names of tables that are being managed as the virtual structured data. Table information of the existing structured database selected by the user to be managed as the virtual structured data is arranged and displayed in this table list.

The user presses a refer button 504 of the virtual structured data management screen 500 to display the information extraction rules 123 created by the user, and selects the information extraction rules 123 to be used. The user thereafter presses an upload button 505 and sends the selected information extraction rules 123 to the data management apparatus 101.

In the ensuing explanation, within the table 1510 of the first database 151, described is an example of extracting, from a nursing care record file as the unstructured data, another disease name as a complication suffered by each patient relative to the patient table, and storing the extracted other disease name as the virtual attribute value in the complication column of the patient table. A sample 506 displays the state where the virtual attribute value extracted from the nursing care record file is stored in the complication column, and the upper part of the sample 506 displays information showing that the virtual attribute value was extracted from the nursing care record file.

Moreover, the complication column of the sample 506 displays “influenza” or a hyphen representing “no applicable” as the extraction result. Moreover, when the user selects a term from the complication column displayed in the sample 506 on the screen, the related file information as the file of the extraction source of that term is displayed. Here, in addition to the file name, it is also possible to display from which part of the file the term was extracted. Moreover, the information extraction rules that were used for extracting that term may also be displayed.

### (1-5) Effect of this Embodiment

As described above, according to this embodiment, an arbitrary attribute is added, as a virtual attribute, to the data included in the structured first database 151, the attribute value of the virtual attribute is registered in the information extraction rules as the result of the search query to the second database 152, and the file of the second database 152 involved in deriving the result of the search query is associated with the information extraction rules as a related file and stored. Subsequently, when the related file is updated, the search query is re-executed and the execution result thereof is used as the new attribute value of the virtual attribute.

Consequently, it is possible to acquire the intended extracted data by merely accessing the virtual structured data 153 which reflects the state of the latest unstructured data without having to execute re-extraction processing to the unstructured data of the extraction source each time search processing is executed to the virtual structured data 153.

### (2) Second Embodiment

In the ensuing explanation, described is a case where a newly created file is added, in addition to the update and deletion of a file, with regard to the file of the second database 152. When a new file is added, there are cases where the virtual attribute value of the table 1510 included in the first database 151 may change. Thus, in this embodiment, whether the added file will affect any of the virtual attribute values is identified.

### (2-1) Configuration of data management apparatus

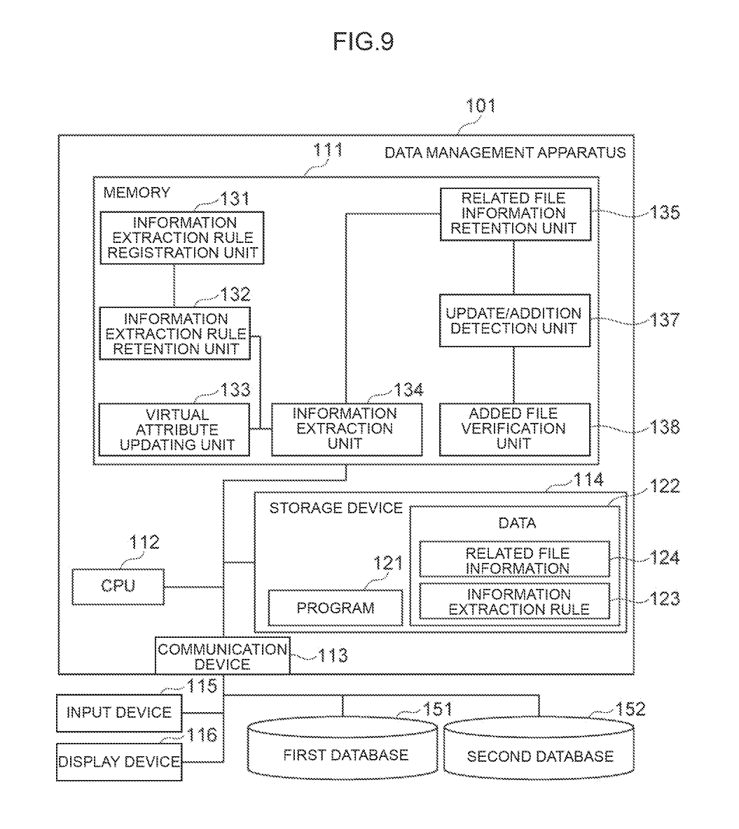

Since the data management apparatus 101 according to this embodiment has the same hardware configuration as the first embodiment, the detailed explanation thereof is omitted. Moreover, the data management apparatus 101 according to this embodiment differs from the first embodiment in comprising an update/addition detection unit 137 and an added file verification unit 138 as shown in FIG. 9.

The update/addition detection unit 137 has a function of detecting the addition of a file to the second database 152 managing unstructured data. The added file verification unit 138 has a function of adding information of the file added to the related file information retention unit 135, and writing the result of extracting information from the added file in the corresponding virtual attribute value of the structured data.

### (2-2) Detailed Operation of Data Management Apparatus

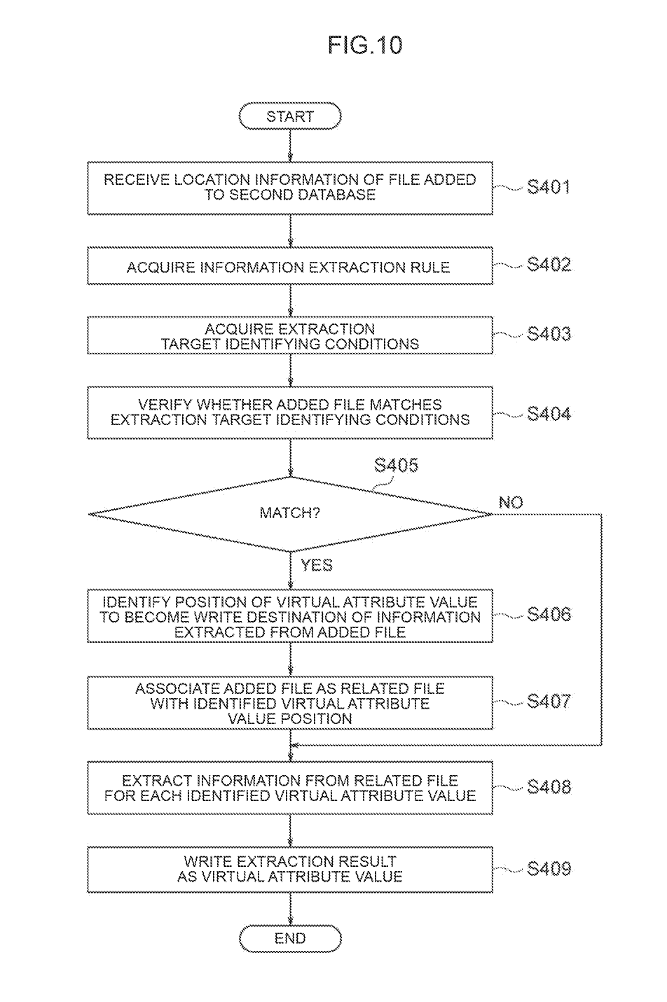

As shown in FIG. 10, the added file verification unit 138 foremost receives, from the addition detection unit 137, location information of the file that was added to the second database 152 (S401). Subsequently, the added file verification unit 138 acquires the information extraction rules 123 from the information extraction rule retention unit 132 (S402).

Subsequently, the added file verification unit 138 acquires, from the information extraction rules 123, the extraction target identifying conditions for identifying the file from which information is to be extracted (S403). In step S403, for instance, when the information extraction rules 123 shown in FIG. 2 are to be used, “database B, nursing care record” is extracted as the extraction target identifying conditions.

Subsequently, the added file verification unit 138 verifies whether the added file matches the extraction target identifying conditions (S404). In this embodiment, whether the added file is data that was added to the database B is a file belonging to the nursing care record is verified.

The added file verification unit 138 determines whether the file is a file that matches the extraction target identifying conditions as a result of the verification performed in step S404 (S405). When it is determined that the file is not a matching file in step S405, the added file verification unit 138 ends the processing. Meanwhile, when it is determined that the file is a matching file in step S405, the added file verification unit 138 executes the processing of step S406.

Subsequently, in step S406, the added file verification unit 138 identifies the position of the virtual attribute value to become the writing destination of the information extracted from the added file by using the output destination identifying conditions of the acquired information extraction rules 123. Next, the added file verification unit 138 associates the added file, as a result file, with the identified virtual attribute value position (S407).

Subsequently, the information extraction unit 134 executes the information extraction processing to the related file associated with the related file information 124 for each identified virtual attribute value (S408). Next, the information extraction unit 134 writes the result of the extraction processing executed in step S204, as the virtual attribute value, at the identified writing position in the table 1530 of the virtual structured data 153 (S409).

As described above, after the file to be extracted is added, together with the virtual attribute value identifying information, as a related file to the related file information 124, the update/addition detection unit 137 can detect the update of the added file. Subsequently, if there is any change to the result of extracting information according to the information extraction rules 123 corresponding to the related file, the processing of updating the virtual attribute value in the table 1530 of the virtual structured data 153 is repeated.

Note that, in step S405 described above, even when it is determined that the added file does not match the extraction target identifying conditions, there is a possibility that the added file will match the extraction target identifying conditions in the subsequent update. In the foregoing case, the added file may be stored as an unrelated file, and the processing shown in FIG. 10 may be re-executed when the unrelated file is updated.

Moreover, when there are a plurality of information extraction rules corresponding to the added file, this means that there are a plurality of extraction target identifying conditions, and all of such extraction target identifying conditions are verified regarding the added file. In order to shorten this verification processing, it is also possible to extract a common denominator from the plurality of extraction target identifying conditions, and verify the same conditions by performing the verification using the common denominator.

### (2-3) Effect of this Embodiment

As described above, according to this embodiment, even when a new file is added to the unstructured data, the user can perform a search of the structured data which reflects the latest information that can be extracted from the new file. Moreover, as with the first embodiment, the time until the search result is obtained can be shortened since the information extraction processing does not need to be executed to the unstructured data each time the user executes a search of the structured data.

### (3) Third Embodiment

In the ensuing explanation, as with the first embodiment, a search query is executed to the unstructured data, processing of extracting information from the thus obtained file is executed, and the extraction result thereof is written in the virtual attribute value showing one feature of the data included in the structured data that can be identified based on the information extraction rules. When large quantities of data are included in the structured data, there are cases where it is difficult to uniquely identify the position of the virtual attribute value where the information extraction result is to be written.

Thus, in this embodiment, explained is an example of a virtual structured data management apparatus which identifies the position of the virtual attribute value where the information extraction result is to be written by using the attribute values of attributes other than the virtual attributes among the data included in the structured data.

### (3-1) Configuration of Data Management Apparatus

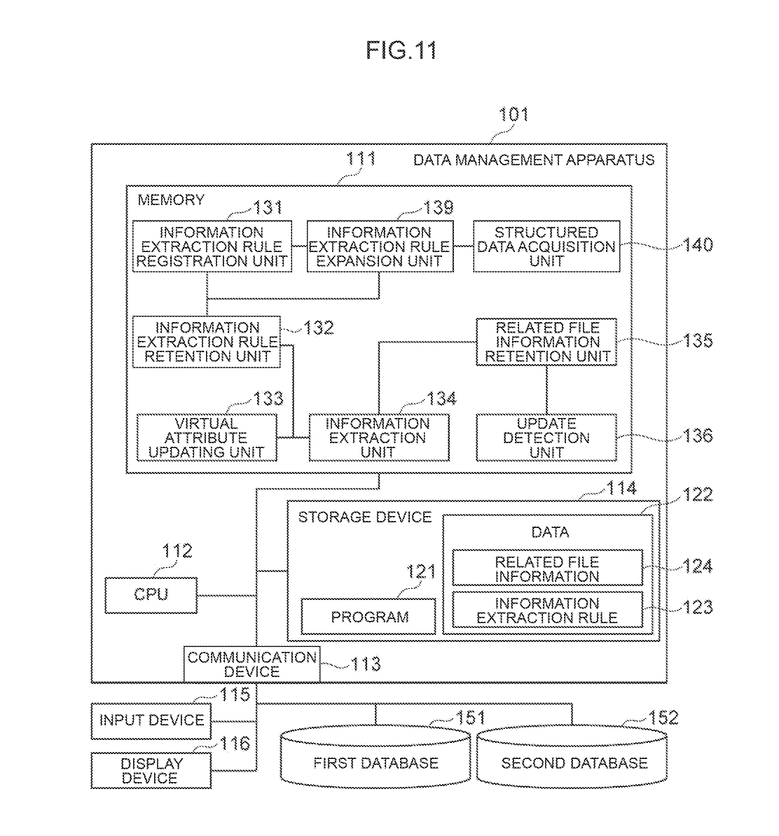

Since the data management apparatus 101 according to this embodiment has the same hardware configuration as the first embodiment, the detailed explanation thereof is omitted. Moreover, the data management apparatus 101 according to this embodiment differs from the first embodiment in comprising an information extraction rule expansion unit 139 and a structured data acquisition unit 140 as shown in FIG. 11.

The structured data acquisition unit 140 has a function of acquiring the structured data related to the received information extraction rules 123. The information extraction rule expansion unit 139 has a function of expanding the information extraction rules 123 by using the structured data acquired with the structured data acquisition unit 140.

### (3-2) Detailed Operation of Data Management Apparatus

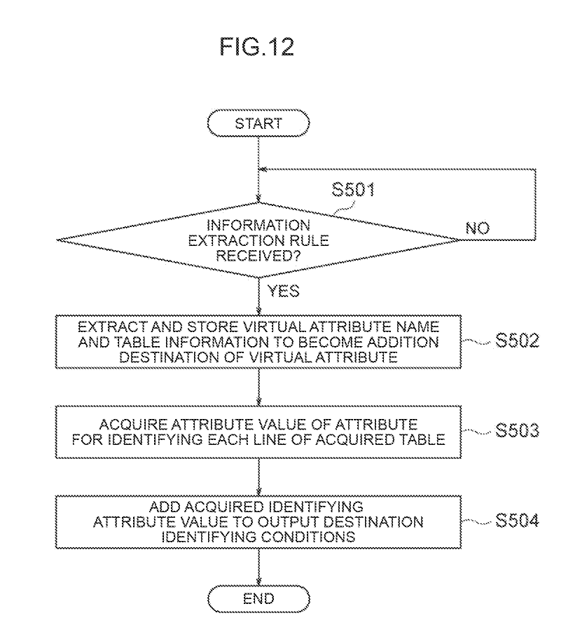

The processing of expanding the information extraction rules when the information extraction rules 123 are given are now explained with reference to FIG. 12.

As shown in FIG. 12, the information extraction rule registration unit 131 determines whether the information extraction rules 123 have been received via the communication device 113 or the input device 115 (S501).

Subsequently, when it is determined that the information extraction rules 123 have been received in step S501, the information extraction rule registration unit 131 extracts the virtual attribute name included in the information extraction rules 123 and the information set in the virtual attribute addition destination, and stores the table information to become the virtual attribute name and the virtual attribute addition destination in the information extraction rule retention unit 132 (S502). In step S502, for instance, let it be assumed that the table 1510 of the patient information included in the first database 1510 shown in FIG. 3 has been extracted.

Subsequently, the structured data acquisition unit 140 acquires the attribute value of the attribute for identifying each line of the table 1510 acquired in step S502 (S503). In step S503, the value for identifying each line of the table 1510 is an attribute value that differs among each line included in the table 1510, and is a value capable of uniquely identifying each line. For example, when the patient names are all different, only the patient name may be used, or when each line is to be uniquely identified by combining the patient name and the date of admission, the combination of the patient name and the date of admission may also be used. Moreover, a patient ID that is set for identifying each line of the table 1510 may also be used.

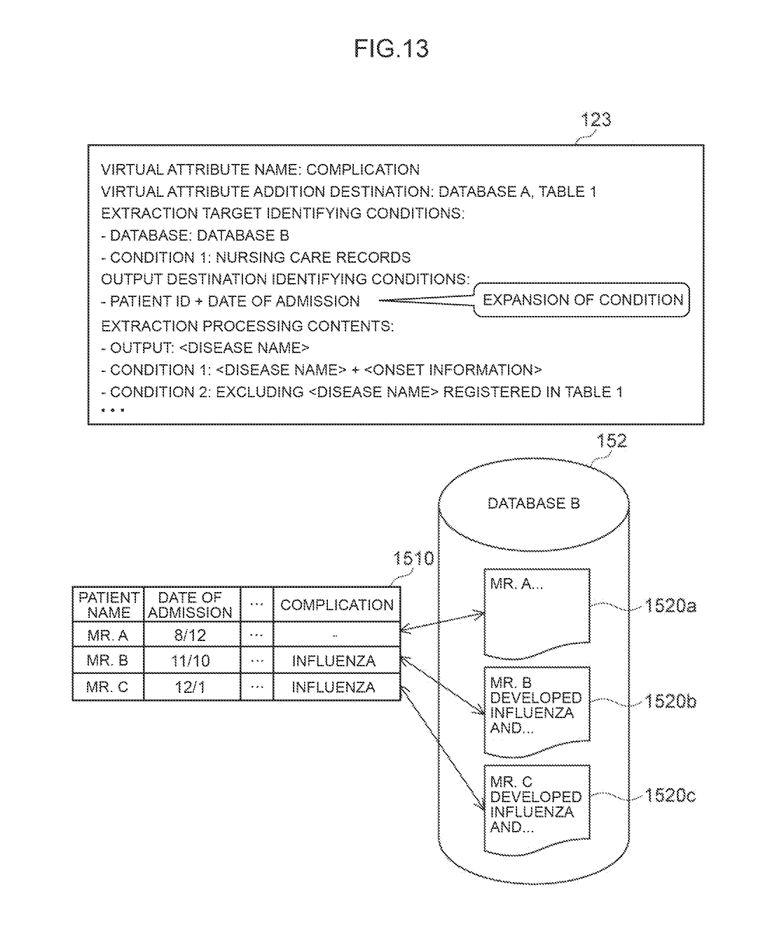

Subsequently, the information extraction rule expansion unit 139 adds the identifying attribute value for identifying each line acquired in step S503 to the output destination identifying conditions of the information extraction rules 123 (S504). As shown in FIG. 13, the information extraction rule expansion unit 139 adds the patient name and the date of admission for identifying each line of the table 1510 to the output destination identifying conditions of the information extraction rules 123.

Moreover, in the processing of associating the related file with the virtual attribute value identifying information showing the position of the specific virtual attribute value that is implemented in the foregoing virtual attribute value/initial value determination processing, the related file is foremost identified based on the expanded output destination identifying conditions. Subsequently, the related file is associated with information for identifying the position of the virtual attribute value of the record containing the attribute value that was used for expanding the output destination identifying conditions.

For example, in FIG. 13, when the virtual attribute addition destination is the table 1 of the database A, Mr. A, Mr. B, and Mr. C as the patient names become the attribute values for expanding the output destination identifying conditions. When the virtual attribute name is “complication”, the related to the virtual attribute value thereof exists in the database B, and the related file containing the description concerning Mr. A is associated with the information for identifying the position of the virtual attribute of the record in which the patient name is “Mr. A”.

The thus expanded output destination identifying conditions are displayed as the expansion rules related to the related file on the virtual structured data management screen 500 shown in FIG. 8 to be presented to the user. In the example of FIG. 8, for instance, “patient name & date of admission@patient table” may be displayed as the expansion rule. This means that a file containing information of both the patient name and the data of admission of the patient table, which is being managed as the virtual structured data, becomes a related file.

When rules concerning the related file are not to be expanded as described above, search of the unstructured data included nursing care records and disease names. Nevertheless, by using the expanded rules of this embodiment, upon searching the unstructured data, it is possible to further narrow down the files to be extracted as those including a nursing care record and a disease name, and in which the patient name is Mr. C and the date of admission is December 1.

### (3-3) Effect of this Embodiment

As described above, according to this embodiment, the position of the virtual attribute value where the result of extracting information from the unstructured data can be identified by using the attribute values of attributes other than the virtual attributes of the data included in the structured data. It is thereby possible to simplify the description of the rules for identifying the writing destination of the information extraction result even when large quantities of data are included in the structured data.

### (4) Fourth Embodiment

In the first embodiment, a file included in the unstructured data related to the determination of the virtual attribute value of a virtual attribute of the structured data is stored in the related file information 124 as a related file. Subsequently, information is extracted from the related file and the information extraction result is written as the virtual attribute value. When the user wishes to know the details of the information of the information extraction source, the use may acquire the related file itself and refer to the contents of the related file. Here, when there are numerous related files, it will be difficult for the user to view the contents of all related files.

Thus, in this embodiment, the strength of connection with the data is managed for a plurality of related files by using the attribute values of attributes other than the virtual attributes of the data included in the structured data. The user is thereby able to refer to a file having a strong connected with the extracted data in cases where there are numerous related files.

### (4-1) Configuration of Data Management Apparatus

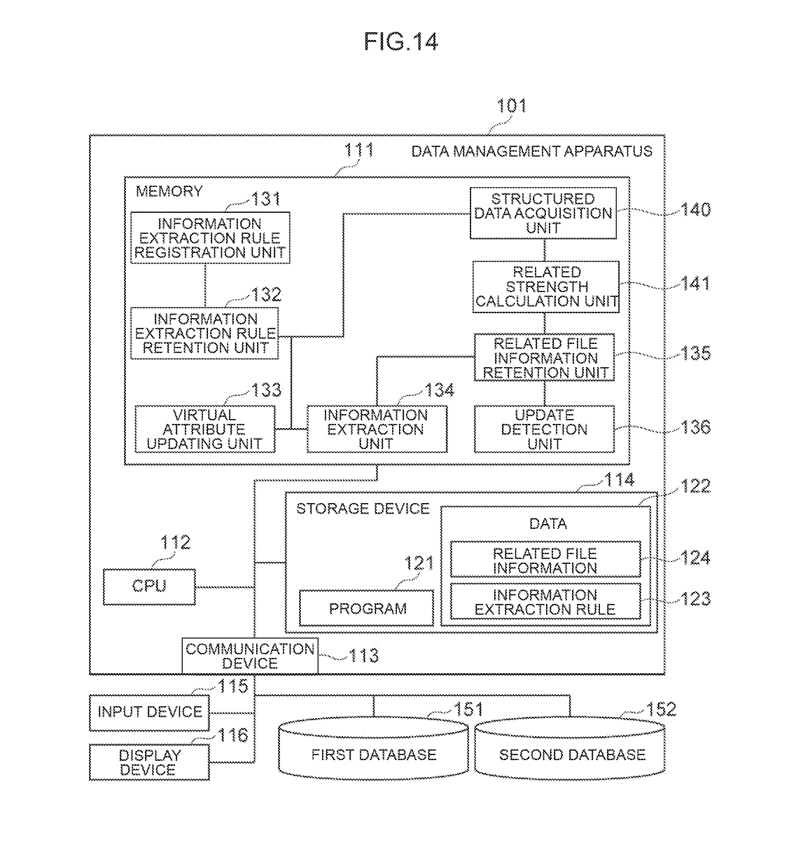

Since the data management apparatus 101 according to this embodiment has the same hardware configuration as the first embodiment, the detailed explanation thereof is omitted. Moreover, the data management apparatus 101 according to this embodiment differs from the first embodiment in comprising a structured data acquisition unit 140 and a related strength calculation unit 141 as shown in FIG. 14.

The structured data acquisition unit 140 has a function of acquiring the structured data related to the received information extraction rules 123. The related strength calculation unit 141 has a function of calculating the related strength of the related file and the virtual attribute value by using the structured data acquired with the structured data acquisition unit 140.

### (4-2) Detailed Operation of Data Processing Apparatus

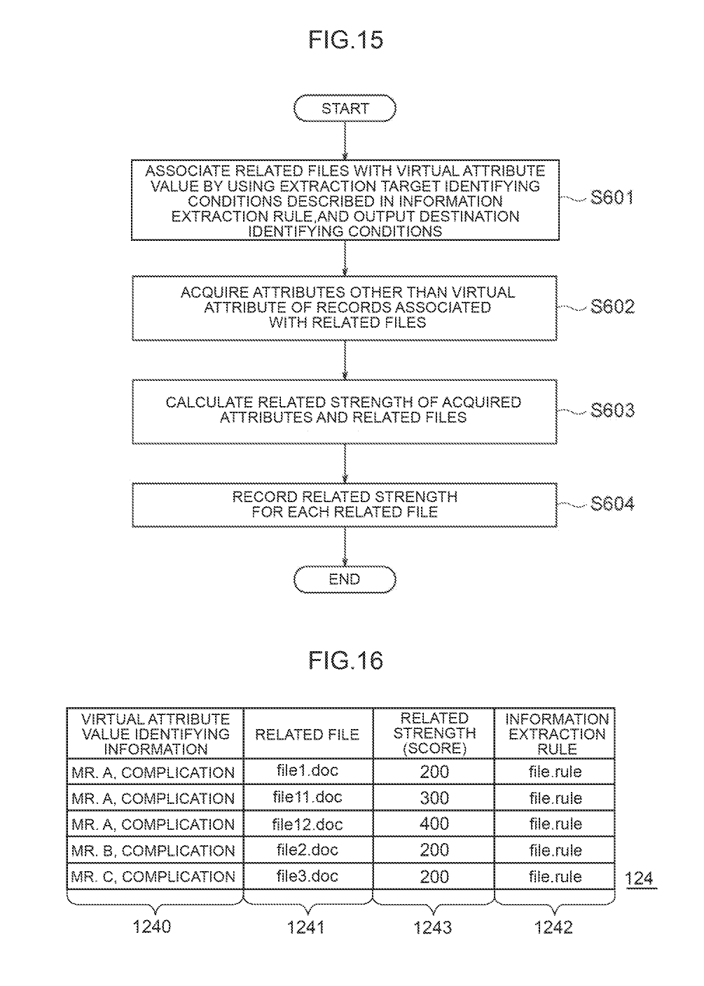

The processing of calculating the related strength of the related file and the virtual attribute value simultaneously with identifying the related file is now explained with reference to FIG. 15.

As shown in FIG. 15, the information extraction rule registration unit 131 foremost associates the related file with the virtual attribute value by using the extraction target identifying conditions described in the information extraction rules 123, and the output destination identifying conditions (S601).

Next, the structured data acquisition unit 140 acquires the attribute values other than the virtual attribute values of the record associated with the related file in step S601 (S602).

Subsequently, the related strength calculation unit 141 calculates the related strength of the attribute value acquired in step S602 and the related file (S603). As the related strength, the number of times that the attribute value acquired in step S602 appears in the related file may also be counted. If the attribute value is character string, the number of times that its equivalent term or synonymous word appears may also be counted. Moreover, it is also possible to weigh the respective records for each attribute value depending on redundancy, and calculate a value obtained by multiplying the number of appearances by the weighting coefficient. Moreover, when a plurality of attribute values are acquired in step S603, the configuration information in the related file, such as the closeness of the appearance position of the plurality of attribute values within the related file, may also be used.

Subsequently, the related strength calculation unit 141 stores the related strength calculated based on the foregoing methods in the related file information 124 for each related file (S604). Specifically, the related strength calculation unit 141 stores, for each related file, the calculated related strength (score) in the related strength (score) column 1243 of the related file information 124 shown in FIG. 16.

The related strength (score) set in steps S603 and S604 are used according to the user's file request. For example, when the user is to refer to the related file as the extraction source in order to conduct a detailed survey of the virtual attribute values of “Mr. A, complication”, it is possible to present file12.doc, file11.doc, and file1.doc in ascending order of the related strength (score).

### (4-3) Effect of this Embodiment

As described above, according to this embodiment, when there are a plurality of related files, the related files can be rearranged and presented to the user in ascending order of the connection strength with the data included in the structured data as the related source. Consequently, when the user is to refer to a related file, the user can identify the related to be preferentially referenced among a plurality of related files based on the connection strength thereof.

### (5) Fifth Embodiment

In the first embodiment, objects contained in the file are extracted, and the extraction result is registered as the virtual attribute value of the data included in the structured data. When the file to be extracted is a document, words contained in that document or synonymous words and equivalent terms of those words can be extracted as related words. Moreover, when the file to be extracted is a video, the image and name of that video may be extracted. Moreover, a file to be extracted contains, in addition to objects that are expressly expressed in the file, various types of information that can be obtained by analyzing the information in the file such as the category or class of the file, prediction of information that will appear in the future, and distinction of whether the information is positive information or negative information. Thus, in this embodiment, in order to extract the foregoing information, performed is analytical processing or data mining of acquiring the statistics of information contained in the file and determining the result thereof.

### (5-1) Configuration of Data Management Apparatus

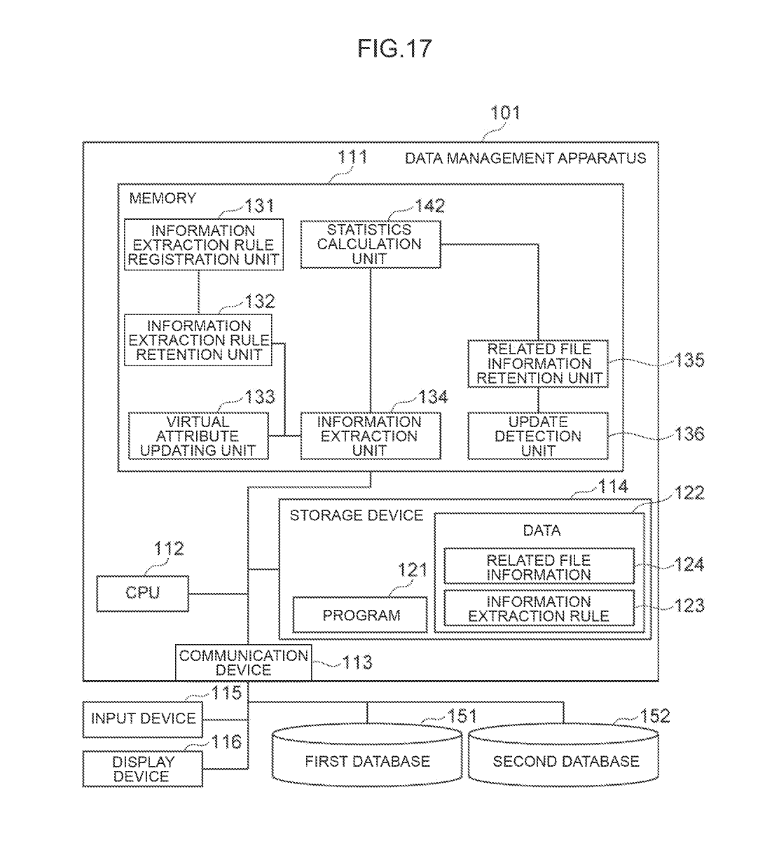

Since the data management apparatus 101 according to this embodiment has the same hardware configuration as the first embodiment, the detailed explanation thereof is omitted. Moreover, the data management apparatus 101 according to this embodiment differs from the first embodiment in comprising a statistics calculation unit 142 as shown in FIG. 17.

The statistics calculation unit 142 has a function of implementing predetermined statistics calculation to information that is incidental to the related file. When extracting information from a related file associated with the virtual attribute value of data, the statistics calculation unit 142 performs analytical processing or data mining of acquiring statistical information regarding the information in one or more related files, and determining the result thereof. Subsequently, by writing the result of the analytical processing or the data mining performed by the statistics calculation unit 142 in the structured data as the virtual attribute value, it is possible to structure information of an object that is not expressly expressed in the related file.

### (5-2) Detailed Operation of Data Management Apparatus

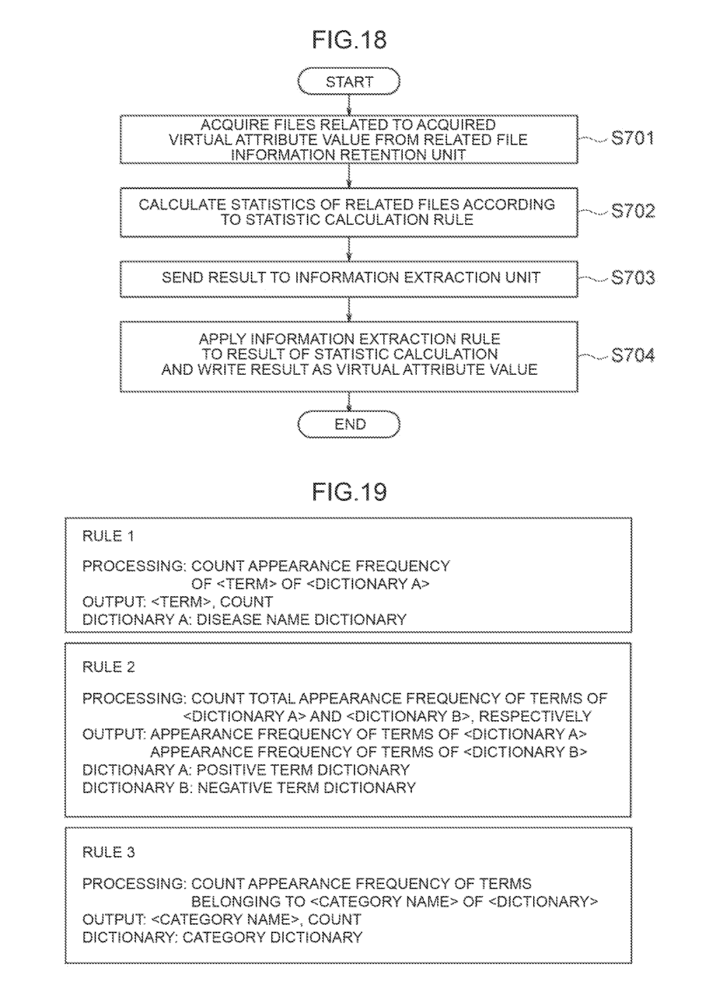

The information extraction processing of using the statistical information of the related file upon extracting information from the unstructured data is now explained with reference to FIG. 18.

The statistics calculation unit 142 starts the following processing when the virtual attribute value to become the information extraction destination from the unstructured data is identified after the information extraction rules 123 are registered or after the file of the unstructured data is updated or added.

As shown in FIG. 18, the statistics calculation unit 142 foremost acquires a file related to the identified virtual attribute value from the related file information retention unit 135 (S701).

Subsequently, the statistics calculation unit 142 implements the statistics calculation to one or more related files according to predetermined statistics calculation rules (S702). As the statistics calculation rules used in step S702, for example, the statistics calculation rules shown in FIG. 19 may be exemplified.

One of the statistics calculation rules “rule 1” shown in FIG. 19 is a rule of calculating the number of words that match the words that appear in the dictionary. Moreover, one of the statistics calculation rules “rule 2” is a rule of tabulating the appearance frequency of words that have a positive meaning such as “possible”, “recovery”, and “get better” and words that have a negative meaning such as “not possible”, “aggravation”, and “getting worse”. Moreover, one of the statistics calculation rules “rule 3” is a rule of tabulating the number of words belonging to a specific category or class, such as words related to medical treatment, words related to rehabilitation, and words related to meals.

After implementing the aggregate result according to the foregoing statistics calculation rules, the statistics calculation unit 142 notifies the aggregate result to the information extraction unit 134 (S703).

The information extraction unit 134 applies the information extraction rules to the result of the statistics calculation notified in step S703, and used the result thereof as the information extraction result and writes this in the identified virtual attribute value (S704). As one example of the information extraction rules to be applied in step S704, for instance, there is a rule of registering the word of the disease name having the highest appearance frequency. Another example is a rule of comparing the number of positive information and the number of negative information, adopting positive when there is more positive information. Another example is a rule of writing the category name when there are numerous words of a specific category. Another example is a rule of registering words that are derived from the names of the plurality of categories that appeared.

In the foregoing example, a case of implementing statistics calculation to the information in the file included in the unstructured data was explained, but the statistics calculation may also be implemented by using the metadata that is incidental to the file. For example, used may be person information such as the creator information and updater information of the file, and the persons included in the file. For example, the file creator information may be used so that only the files created or updated by a specific creator are subject to the statistics calculation. It is thereby possible to increase the reliability of the information by performing statistics calculation to the files that were created or updated by a reliable person.

Moreover, incidental metadata other than the person information may also be used. For example, the creation time and update time of the file or the time information contained in the file may also be used. For example, by using the time information and narrowing down the related files to be subject to the statistics calculation, it will be possible to use only new information. Moreover, it is also possible to extract the time information incidental to the file and the tendency of the change in numerical value from the numerical value information in that file, and extract the future numerical value as a predicted value.

In addition to the person information and time information described above, various types of metadata such as position information, language information, color information, rights information, access authority information or version information may also be used.

### (5-3) Effect of this Embodiment

As described above, according to this embodiment, it is possible to structure information of an object that is not expressly expressed in the file in the unstructured data, and manage the information of that object as the virtual attribute value of the data included in the structured data.

### (6) Other Embodiments

In the foregoing embodiments, data from which information is to be extracted was unstructured data, but the data from which information is to be extracted may also be arbitrary data including structured data. In the foregoing case, the target arbitrary data group is divided into suitable partial data. Subsequently, the divided partial data is treated in the same manner as the related files described above, and the update of the partial data is thereby detected. When the partial data is updated, the result obtained by applying the information execution rules to the partial data is updated as the virtual attribute value of the virtual structured data.

The present invention is not limited to the embodiments described above, and also covers various modified examples. The foregoing embodiments were described in detail in order to facilitate the explanation of the present invention, but the present invention is not necessarily limited to those comprising all of the explained configurations. Moreover, a part of a configuration of a certain embodiment may be replaced with a configuration of another embodiment, and a configuration of another embodiment may also be added to a configuration of a certain embodiment. Moreover, another configuration may be added to, deleted from, or replaced with a part of the configuration of the respective embodiments.

Moreover, all or a part of each of the foregoing configurations, functions, processing units, and processing means may also be realized using hardware such as being designed using an integrated circuit. Moreover, each of the foregoing configurations and functions may also be realized as software being a processor interpreting and executing programs for realizing the respective functions. Information such as programs, tables, and files that realize the respective functions may be stored in a memory, a hard disk, a recording device such as an SSD (Solid State Drive) or a recording medium such as an IC card, an SD card, or a DVD. Moreover, control lines and information lines were indicated to the extent required for explaining the present invention, and all control lines and information lines of a product are not necessarily shown. In effect, it may be considered that substantially all configurations are mutually connected.

[Reference Signs List]

| | |
|---|---|
| 101 | Data management apparatus |
| 111 | Memory |
| 112 | CPU |
| 113 | Communication device |
| 114 | Storage device |
| 115 | Input device |
| 116 | Display device |
| 131 | Information extraction rule registration unit |
| 132 | Information extraction rule retention unit |
| 133 | Virtual attribute updating unit |
| 134 | Information extraction unit |
| 135 | Related file information retention unit |
| 136 | Update detection unit |

1. A data management apparatus, comprising:
a storage unit which stores a first database for retaining structured data in which a plurality of data features are structured based on attributes and attribute values, and a second database for retaining unstructured data in file units; and
a control unit which combines the structured data and the unstructured data and manages the combination as virtual structured data which is accessed during an execution of a search query to the second database, uses attribute values of virtual attributes of the virtual structured data as values that were extracted from files of the second database based on predetermined information extraction rules, and updates the attribute values of the virtual attributes of the virtual structured data when the files of the second database including the unstructured data are updated.

2. The data management apparatus according to claim 1,
wherein the control unit:
generates virtual structured data by adding the attribute values of the virtual attributes to data included in the first database, registers information extraction rules in which the attribute values of the virtual attributes are used as a result of the search query to the second database, and associates files of the second database involved in deriving the result of the search query with the information extraction rules as related files and stores the association; and
when the related files are updated, re-executes the search query and uses an execution result thereof as new attribute values of the virtual attributes.

3. The data management apparatus according to claim 1,
wherein the control unit:
when a new file is added to the second database, verifies whether the added file matches the conditions of the search query described in the information extraction rules, re-executes the search query when the added file matches the conditions, and uses an execution result thereof as new attribute values of the virtual attributes.

4. The data management apparatus according to claim 1,
wherein the control unit:
uses a search query for searching the attribute values of the virtual attributes as a first query;
adds, to the first query, attribute values of attributes included in data other than the virtual attributes as a condition for searching the attribute values of the virtual attributes, and uses a result thereof as a second search query; and
registers the information extraction rules of using the result of the second search query as the attribute values of the virtual attributes.

5. The data management apparatus according to claim 2,
wherein the control unit:
measures the number of attribute values that are included relative to the attributes other than the virtual attributes of the data; and
associates, with the related files, the strength of a connection of the data and the related files according to the measured number of attribute values, and stores the association.

6. The data management apparatus according to claim 1,
wherein the control unit:
calculates statistical information by measuring the number of specific objects that appear in the files of the search result relative to the search result of the second database;
manages mapping information for deriving specific values according to the measured number of objects; and
uses the derived values as the attribute values of the virtual attributes.

7. The data management apparatus according to claim 6,
wherein the control unit:
acquires person information associated with the related files such as including creator information and updater information of the related files and person information included in the files; and
combines the person information acquired in relation to the related files and the statistical information of objects extracted from the related files, and uses the combined information of the person/object statistical information as attribute value information of the virtual attributes.

8. The data management apparatus according to claim 6,
wherein the control unit:
acquires time information such as creation date/time and update date/time of the related files, registration date/time in the second database, and time information included in the files; and
rearranges the related files in acquired time information order, measures the number of specific objects included in the related files, extracts a transition of the number of objects that appear every hour by comparing the measured number of objects among the related files, and uses the result thereof as tendency information of the virtual attributes.

9. The data management apparatus according to claim 1,
wherein the control unit:
manages, in combination with the second database for retaining data in file units, an arbitrary database for retaining data by separating the data into specific categories;
registers extraction rules in which the extraction result is used as a result of the search query to the arbitrary database;
stores the specific category of the arbitrary database involved in deriving the result of the search query in a same related category as the related files; and
when the related category is updated, re-executes the search query and uses an execution result thereof as new attribute values of the virtual attributes.

10. A data management method in a data management apparatus comprising a storage unit which stores a first database for retaining structured data in which a plurality of features of data are structured based on attributes and attribute values, and a second database for retaining unstructured data in file units, and a control unit which combines the structured data and the unstructured data and manages the combination as virtual structured data which is accessed during an execution of a search query to the second database,
the data management method comprising:
a first step of the control unit using attribute values of virtual attributes of the virtual structured data as values that were extracted from files of the second database based on predetermined information extraction rules; and
a second step of the control unit updating the attribute values of the virtual attributes of the virtual structured data when the files of the second database including the unstructured data are updated.

11. The data management method according to claim 10, further comprising:
a third step of the control unit generating virtual structured data by adding the attribute values of the virtual attributes to data included in the first database;
a fourth step of the control unit registering information extraction rules in which the attribute values of the virtual attributes are used as a result of the search query to the second database;
a fifth step of the control unit associating files of the second database involved in deriving the result of the search query with the information extraction rules as related files and storing the association; and
a sixth step of the control unit re-executing the search query and using an execution result thereof as new attribute values of the virtual attributes when the related files are updated.

12. The data management method according to claim 11, further comprising:
a seventh step of the control unit, when a new file is added to the second database in the sixth step, verifying whether the added file matches the conditions of the search query described in the information extraction rules, re-executing the search query when the added file matches the conditions, and using an execution result thereof as new attribute values of the virtual attributes.

13. The data management method according to claim 12, further comprising:
an eighth step of the control unit, the fourth step, using a search query for searching the attribute values of the virtual attributes as a first query, adding, to the first query, attribute values of attributes included in data other than the virtual attributes as a condition for searching the attribute values of the virtual attributes and using a result thereof as a second search query, and registering the information extraction rules of using the result of the second search query as the attribute values of the virtual attributes.

14. The data management method according to claim 13, further comprising:
a ninth step of the control unit, in the fifth step, measuring the number of attribute values that are included relative to the attributes other than the virtual attributes of the data, and associating, with the related files, the strength of connection of the data and the related files according to the measured number of attribute values and storing the association.

15. A non-transitory recording medium having recorded thereon a program for causing a computer to function as a data management apparatus comprising:
a storage unit which stores a first database for retaining structured data in which a plurality of data features are structured based on attributes and attribute values, and a second database for retaining unstructured data, which is not structured, in file units; and
a control unit which combines the structured data and the unstructured data and manages the combination as virtual structured data which is accessed during an execution of a search query to the second database, uses attribute values of virtual attributes of the virtual structured data as values that were extracted from files of the second database based on predetermined information extraction rules, and updates the attribute values of the virtual attributes of the virtual structured data when the files of the second database including the unstructured data are updated.
